(19) United States
(12) Patent Application Publication
(10) Pub. No.: US 2007/0010194 A1
(43) Pub. Date: Jan. 11, 2007

(54) Receiver Capable of Receiving and Processing Digital Video Broadcasting Signals and Digital Audio Broadcasting Signals

(76) Inventor: Kun-Yi Lin, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,941

(22) Filed: Nov. 4, 2005

(30) Foreign Application Priority Data
Jul. 7, 2005 (TW) 094123034

(51) Int. Cl. H04H 7/00

(52) U.S. Cl. 455/3.06

(57) ABSTRACT

A receiver capable of receiving and processing digital video broadcasting signals and digital audio broadcasting signals includes a housing, an antenna, a transmitter, a digital video broadcasting tuner, a digital audio broadcasting tuner, a digital video broadcasting demodulator, a digital audio broadcasting demodulator, and a controller. The receiver is also capable of receiving a selection command generated from a software or a hardware to selectively activate the function of viewing the digital video broadcast or the function of listening to the digital audio broadcast. Now a user can own a single receiver instead of having two separate receivers for receiving the digital video broadcast and the digital audio broadcast.

### BACKGROUND OF THE INVENTION

1. Field of the Invention

The present invention relates to a receiver capable of receiving and processing digital video broadcasting signals and digital audio broadcasting signals, more particularly to a receiver capable of receiving a selection command generated from a software or a hardware to selectively activate the function of viewing the digital video broadcast or the function of listening to the digital audio broadcast.

2. Description of the Prior Art

With the coming of the digital age, traditional analog systems of TV and audio stations are gradually being replaced by digital systems. Because of the sensitivity of the signals in analog systems, analog signals are not suitable for transmission in a hostile environment. On the contrary, digital video broadcasting (DVB) systems and digital audio broadcasting (DAB) systems enable robust communications in extremely hostile environments. This robust feature provides stable and superior quality TV and radio programs. Additionally, frequency bands are utilized more efficiently in digital systems than they are in their analog counterparts. That is, in comparison with analog systems, digital systems are capable of transmitting more programs within the same frequency band. Moreover, many additional services of data broadcasting can be provided by the DVB systems.

The size of the conventional receivers of DVB systems or DAB systems is usually too large to be conveniently placed in an area with limited space. As the number of application products of computer peripherals are increasing, when installing and utilizing the receiver, users of notebook computers or desktop computers often find the receiver inconvenient in terms of size and also the receiver takes up space; furthermore, there is no receiver in the market that has the DVB receiving function and the DAB receiving function combined, if a consumer wants to view digital television and listen to digital radio, the consumer has to purchase a DVB receiver and a DAB receiver separately, hence the consumer's spending burden is increased and as well as increased space that will be taken up by installing the device.

### SUMMARY OF THE INVENTION

The claimed invention provides a receiver capable of receiving a selection command from software or hardware to selectively activate the function of viewing digital video broadcast or the function of listening to digital audio broadcast.

The claimed invention discloses a receiver capable of receiving and processing digital video broadcasting signals and digital audio broadcasting signals. The receiver includes a housing, an antenna for receiving digital video broadcasting signals or digital audio broadcasting signals transmitted from a transmitter, a digital video broadcasting tuner installed within the housing for converting the frequency of the digital video broadcasting signals received by the antenna, a digital audio broadcasting tuner installed within the housing for converting the frequency of the digital audio broadcasting signals received by the antenna, a digital video broadcasting demodulator installed within the housing and coupled to the digital video broadcasting tuner for demodulating signals transmitted from the digital video broadcasting tuner, a digital audio broadcasting demodulator installed within the housing and coupled to the digital audio broadcasting tuner for demodulating signals transmitted from the digital audio broadcasting tuner, a transmission interface for transmitting signals demodulated by the digital video broadcasting demodulator or the digital audio broadcasting demodulator to a corresponding video-audio presenting device; and a controller installed within the housing for controlling the transmission interface to transmit signals demodulated by the digital video broadcasting demodulator or the digital audio broadcasting demodulator to the corresponding video-audio presenting device according to a selection command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external view of a receiver 10 according to the first embodiment of the present invention.

FIG. 2 illustrates a functional block diagram of a receiver 10 according to the first embodiment of the present invention.

FIG. 3 illustrates a functional block diagram of a receiver 50 according to the second embodiment of the present invention.

FIG. 4 illustrates an external view of a receiver 60 according to the third embodiment of the present invention.

FIG. 5 illustrates a functional block diagram of a receiver 60 according to the third embodiment of the present invention.

### DETAILED DESCRIPTION

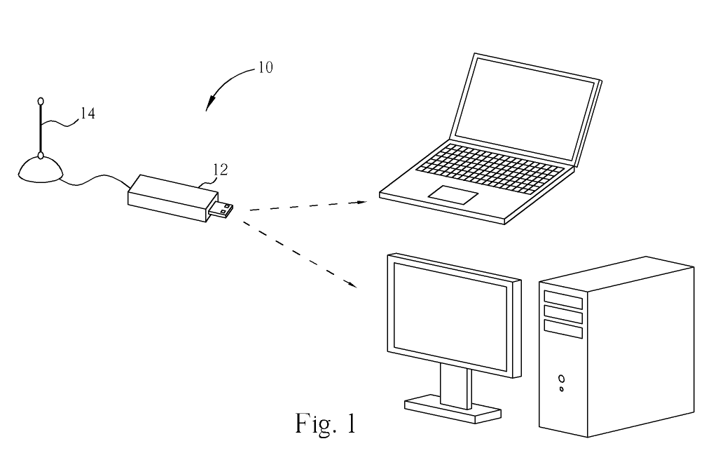

Please refer to FIG. 1. FIG. 1 illustrates an external view of a receiver 10 according to the first embodiment of the present invention. The receiver 10 can be represented in a form such as a USB dongle, which means that the USB interface can be inter-connected with a computer device (such as a notebook computer or a desktop computer) for viewing digital television or listening to digital radio. The receiver includes a housing 12 for covering internal components, and an antenna 14 installed externally on the housing 12 for receiving digital video broadcasting (DVB) signals or digital audio broadcasting (DAB) signals transmitted from a transmitter. The antenna can be a wideband antenna that receives frequency bands including the DVB signals and the DAB signals, and the DVB signal can be a signal that is compliant with a signal of digital video broadcasting-terrestrial (DVB-T) or a signal that is compliant with a signal of advanced television system committee (ATSC). The antenna 14 can also be installed within the housing 12 so that the size of the receiver can be reduced.

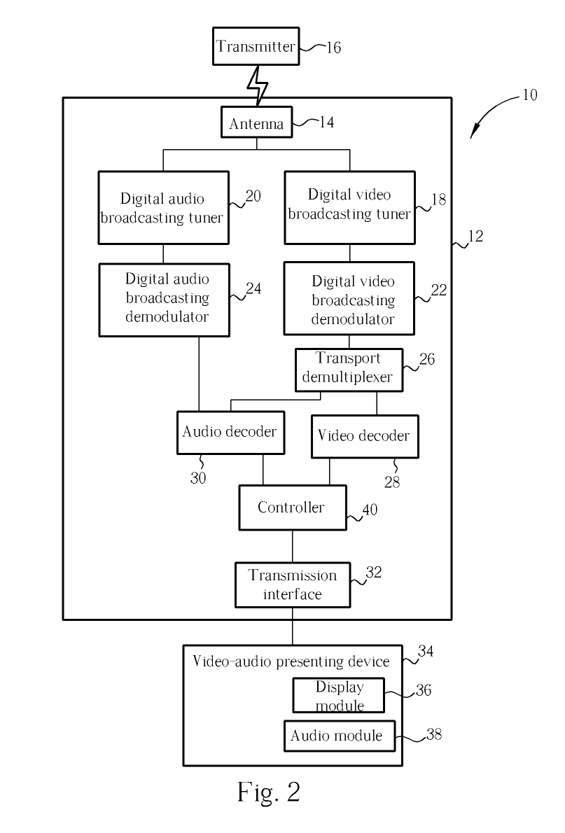

Please refer to FIG. 2. FIG. 2 illustrates a functional block diagram of a receiver 10 according to the first embodiment of the present invention. The receiver 10 receives the DVB signals or the DAB signals transmitted from a transmitter 16 via an antenna 14, and the transmitter 16 can be a transmission base for the DVB signals or the DAB signals. The receiver 10 further includes a digital video broadcasting (DVB) tuner 18 installed within the housing 12 for adjusting the frequency of the DVB signals received by the antenna 14 to a selected channel and lowering the frequency into a low frequency, a digital audio broadcasting (DAB) tuner 20 installed within the housing 12 for adjusting the frequency of the DAB signals received by the antenna 14 to a selected channel and lowering the frequency into a low frequency, a digital video broadcasting (DVB) demodulator 22 installed within the housing 12 and coupled to the DVB tuner 18 for demodulating signals transmitted from the DVB tuner 18. The DVB demodulator 22 can be a radio frequency (RF) silicon tuner. Furthermore, the receiver 10 includes a digital audio broadcasting (DAB) demodulator 24 installed within the housing 12 and coupled to the DAB tuner 20 for demodulating signals transmitted from the DAB tuner 20. The DAB demodulator 24 can be a radio frequency silicon tuner. The receiver 10 further includes a transport demultiplexer 26 installed within the housing 12 for sorting signals demodulated by the digital video broadcasting demodulator 22 into video signals and audio signals, a video decoder 28 installed within the housing 12 for decoding the video signals transmitted from the transport demultiplexer 26, an audio decoder 30 installed within the housing 12 for decoding signals demodulated by the DAB demodulator 24 and the audio signals transmitted from the transport demultiplexer 26, and a transmission interface 32 which can be a USB, PCMCIA, PCI, mini PCI or PCI-E transmission interface for transmitting decoded video signals from the video decoder 28 and decoded audio signals from the audio decoder 30 to a video-audio presenting device 34. The video-audio presenting device 34 can be a computer device such as a notebook computer or a desktop computer, and the video-audio presenting device 34 has a display module 36 for displaying images corresponding to the decoded video signals from the video decoder 28, and an audio module 38 for outputting sound corresponding to the decoded audio signals from the audio decoder 30 or outputting sound corresponding to the signals demodulated by the DAB demodulator 24. The receiver 10 further includes a controller 40 installed within the housing 12 for controlling the transmission interface 32 to transmit signals demodulated by the DVB demodulator or the DAB demodulator to the video-audio presenting device 34 according to a selection command, wherein if the transmission interface 32 is a USB transmission interface, then the controller 40 is a USB controller.

The receiver 10 of the present invention is capable of receiving and processing the DVB signals and the DAB signals, which will be explained in the following. Firstly, a user can utilize a software at the video-audio presenting device 34 end to input the selection command to be transmitted to the controller 40 via the transmission interface 32, and the selection command is utilized for selectively activating the function of viewing the digital video broadcast or the function of listening to the digital audio broadcast. After receiving the selection command, the controller 40 will transmit a corresponding signal to the activated tuner and demodulator to select the corresponding tuner and demodulator. For example, when the user wants to view digital video broadcast, the user can input a selection command to select the digital video broadcast at the video-audio presenting device 34 end. At this time, the controller 40 will output a corresponding signal to the DVB tuner 18, the DVB demodulator 22, the transport demultiplexer 26 to connect the DVB tuner 18, the DVB demodulator 22, the transport demultiplexer 26, the video decoder 28, the audio decoder 30 and the controller 40. The user then selects a program channel at the video-audio presenting device 34 via the controller 40, the controller 40 then outputs a signal to the DVB tuner 18 to adjust the frequency of the DVB signals received by the antenna 14 to the frequency of the selected program channel and lowers the signal frequency into a low frequency, and the DVB demodulator 22 then demodulates the signals transmitted from the DVB tuner 18 into digital signals, the demodulated signals will then be sorted into video signals and audio signals, wherein the video signals can be signals that are compliant with MPEG2 video coding standards, and the audio signals can be signals that are compliant with DolbyAC3 or MPEG2 audio coding standards, the video signals and the audio signals will then be transmitted to the video decoder 28 and the audio decoder 30, respectively, for decoding. After the video decoder 28 decompresses the video signal according to an algorithm and after processing image scaling, conversion and displaying on a monitor, the video signal is converted into image data via a digital/analog conversion, as for the audio decoder 30, the audio decoder 30 can decompress and convert data like Dolby Digital data or other stereo audio data into analog audio. Lastly, the controller 40 controls the transmission interface 32 to transmit the decoded signals from the video decoder 28 and the audio decoder 30 to the video-audio presenting device 34, the video-audio presenting device 34 then displays the image data via the display module 36 and plays the audio data via the audio module 38.

Similarly, when the user wants to listen to digital audio broadcasts, the user can input a selection command to select the digital audio broadcast at the video-audio presenting device 34 end. At this time, the controller 40 will output a corresponding signal to the DAB tuner 20, and the DAB demodulator 24 then connects to the DAB tuner 20, the DAB demodulator 24 and the controller 40. The user then selects a program channel at the video-audio presenting device 34 via the controller 40, the controller 40 then outputs a signal to the DAB tuner 20 to adjust the frequency of the DAB signals received by the antenna 14 to the frequency of the selected program channel and lowers the signal frequency into a low frequency, and the DAB demodulator 24 then demodulates the signals transmitted from the DAB tuner 20 into digital signals, the demodulated signals will then be transmitted to the audio decoder 30, the audio decoder 30 then transmits the decoded audio data to the controller 40. Lastly, the controller 40 controls the transmission interface 32 to transmit the decoded signals from the video-audio presenting device 34, and the video-audio presenting device 34 will output corresponding audio signals via the audio module 38.

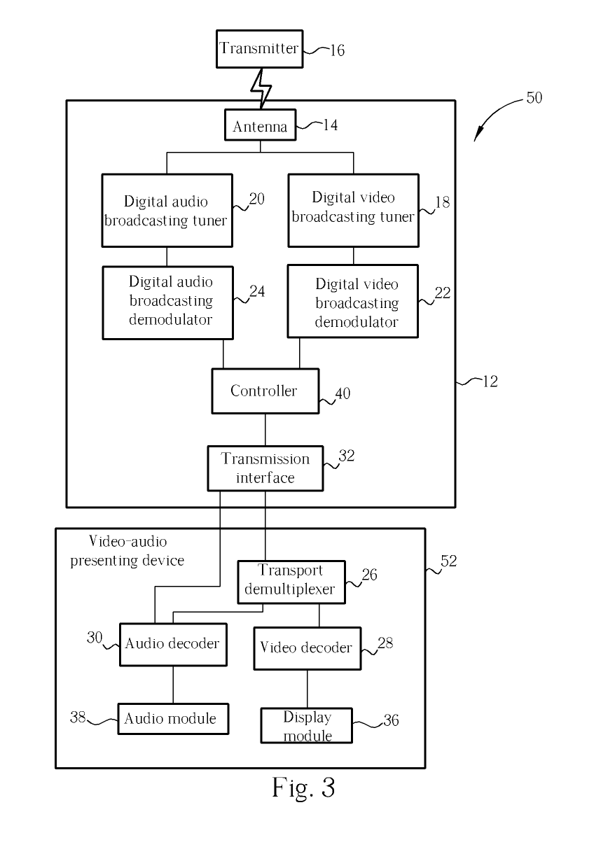

The transport demultiplexer, the video decoder and the audio decoder of the above-mentioned can also be installed within the video-audio presenting device; hence, size and cost of production of the receiver can be reduced. Please refer to FIG. 3. FIG. 3 illustrates a functional block diagram of a receiver 50 according to the second embodiment of the present invention. The first embodiment and the second embodiment include similar component titles and similar functions and architectures. The difference between the first embodiment and the second embodiment is that the receiver 50 of the second embodiment does not include the transport demultiplexer 26, the video decoder 28 and the audio decoder 30 but the transport demultiplexer 26, the video decoder 28 and the audio decoder 30 are being installed within the video-audio presenting device. For this reason, the signals demodulated by the DVB demodulator 22 will be transmitted directly to the controller 40, and the controller 40 then transmits the signals demodulated by the DVB demodulator 22 directly to a video-audio presenting device 52. The video-audio presenting device 52 includes the transport demultiplexer 26, the video decoder 28, and the audio decoder 30, the signals demodulated by the DVB demodulator 22 will be sorted into video signals and audio signals via the transport demultiplexer 26, the video decoder 28 and the audio decoder 30 will then perform decoding on the video signals and the audio signals respectively. Lastly, image data will be displayed on the display module 36 and audio data will be outputted by the audio module 38; similarly, the signals demodulated by the DAB demodulator 24 will be directly transmitted to the controller 40, and the controller 40 will then transmit the signals demodulated by the DAB demodulator 24 directly to the video-audio presenting device 52, the audio decoder 30 will perform decoding on the signals demodulated by the DAB demodulator 24 and lastly the audio data will be outputted by the audio module 38.

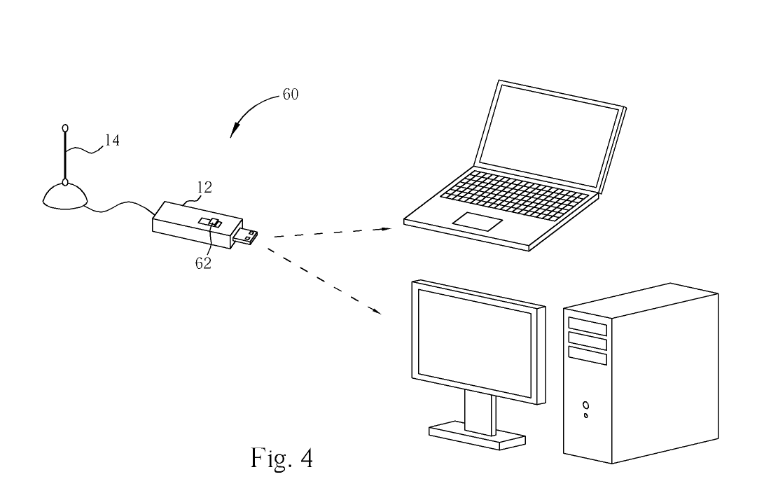

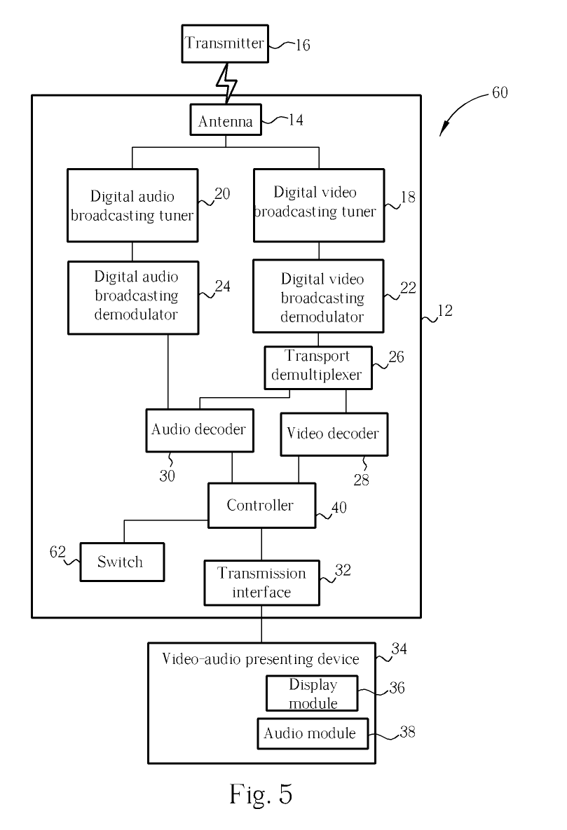

Furthermore, the user can utilize the software at the video-audio presenting device 34 end to input the selection command, the user can also utilize a hardware switching mode between viewing digital video broadcast or listening to digital audio broadcast. Please refer to FIG. 4. FIG. 4 illustrates an external view of a receiver 60 according to the third embodiment of the present invention. The first embodiment and the third embodiment include similar component titles and similar functions and architectures. The difference between the receiver 10 of the first embodiment and the receiver 60 of the third embodiment is that the receiver 60 further includes a switch 62 installed on the housing 12, the user can select whether to view digital video broadcast or to listen to digital audio broadcast by switching the switch 62. Please refer to FIG. 5. FIG. 5 illustrates a functional block diagram of a receiver 60 according to the third embodiment. The controller 40 of the receiver 60 can receive the selection command transmitted from the switch 62. After receiving the selection command, the controller then outputs a corresponding signal to the DVB tuner 18 or the DAB tuner 20. As previously mentioned in the first embodiment, the transmission interface 32 is correspondingly controlled to transmit the signals demodulated by the DVB demodulator 22 or the DAB demodulator 24 to the video-audio presenting device 34, which means that the difference between the first embodiment and the third embodiment is that in the first embodiment the user utilizes the software at the video-audio presenting device 34 end to input the selection command, whereas in the third embodiment the user utilizes the hardware switching method of the switch 62 to carry out the selected command. The method of the hardware inputting the selection command of the third embodiment can also be applicable to the second embodiment in the above-mentioned; therefore, it will not be reiterated. The present invention can also combine the first embodiment or the second embodiment with the selection command input method of the third embodiment. As a result, a priority can be set for the selection command input method. This provides the user with two different selections for switching methods: software switching mode or hardware switching mode.

In comparison to the prior art, the receiver of the present invention is capable of receiving and processing digital video broadcasting signals and digital audio broadcasting signals and the receiver is also capable of receiving a selection command generated from a software or a hardware to selectively activate the function of viewing the digital video broadcast or the function of listening to the digital audio broadcast so that the objective of combining the conventional DVB receiver and DAB receiver can be achieved. Therefore, the user is no longer required to purchase two separate receivers to enjoy high quality digital television programs and to listen to digital entertainment of digital broadcast close to CD quality. Furthermore, the receiver, presented in a USB dongle form, has a small size making it easy to carry around and does not take up much space when utilized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A receiver, comprising:
a housing;
an antenna for receiving digital video broadcasting signals or digital audio broadcasting signals transmitted from a transmitter;
a digital video broadcasting tuner installed within the housing for converting a frequency of the digital video broadcasting signals received by the antenna;
a digital audio broadcasting tuner installed within the housing for converting a frequency of the digital audio broadcasting signals received by the antenna;
a digital video broadcasting demodulator installed within the housing and coupled to the digital video broadcasting tuner for demodulating signals transmitted from the digital video broadcasting tuner;
a digital audio broadcasting demodulator installed within the housing and coupled to the digital audio broadcasting tuner for demodulating signals transmitted from the digital audio broadcasting tuner;
a transmission interface for transmitting signals demodulated by the digital video broadcasting demodulator or the digital audio broadcasting demodulator to a corresponding video-audio presenting device; and
a controller installed within the housing for controlling the transmission interface to transmit signals demodulated by the digital video broadcasting demodulator or the digital audio broadcasting demodulator to the corresponding video-audio presenting device according to a selection command.

2. The receiver of claim 1, wherein the digital video broadcasting signals comply with a standard of digital video broadcasting-terrestrial (DVB-T).

3. The receiver of claim 1, wherein the digital video broadcasting signals comply with a standard of advance television system committee (ATSC).

4. The receiver of claim 1, wherein the antenna is a wideband antenna.

5. The receiver of claim 1, wherein the digital video broadcasting tuner is a radio frequency silicon tuner.

6. The receiver of claim 1, wherein the digital audio broadcasting tuner is a radio frequency silicon tuner.

7. The receiver of claim 1, wherein the transmission interface is a USB interface and the controller is a USB controller.

8. The receiver of claim 1, further comprising:
a transport demultiplexer installed within the housing for sorting signals demodulated by the digital video broadcasting demodulator into video signals and audio signals;
a video decoder installed within the housing for decoding video signals transmitted from the transport demultiplexer, and transmitting the decoded video signals to the controller; and
an audio decoder installed within the housing for decoding audio signals transmitted from the transport demultiplexer, and transmitting the decoded audio signal to the controller.

9. The receiver of claim 1, wherein the controller controls the transmission interface to transmit signals demodulated by the digital video broadcasting demodulator or the digital audio broadcasting demodulator to the corresponding video-audio presenting device according to the selection command transmitted by the transmission interface.

10. The receiver of claim 1, further comprising a switch for inputting the selection command to the controller.
